(19) United States
(12) Patent Application Publication
(10) Pub. No.: US 2014/0362041 A1
(43) Pub. Date: Dec. 11, 2014

(54) TOUCH APPARATUS AND DRIVING METHOD THEREOF

(71) Applicants: Kuo-Hsing Chen, New Taipei City (TW); Yu-Ting Chen, Taoyuan County (TW); Chen-Hao Su, Taichung City (TW)

(72) Inventors: Kuo-Hsing Chen, New Taipei City (TW); Yu-Ting Chen, Taoyuan County (TW); Chen-Hao Su, Taichung City (TW)

(73) Assignee: WINTEK CORPORATION, Taichung City (TW)

(21) Appl. No.: 14/297,631

(22) Filed: Jun. 6, 2014

(30) Foreign Application Priority Data
Jun. 7, 2013 (TW) 102120357

(51) Int. Cl. G06F 3/044

(52) U.S. Cl. CPC G06F 3/044
USPC 345/174

(57) ABSTRACT

A touch apparatus and a driving method thereof are provided. The touch apparatus includes a plurality of firs electrodes, a plurality of second electrodes, a first driving sensing unit, a second sensing driving unit and a control unit. The first electrodes are disposed sequentially along a first direction, and each second electrode is adjacent to the corresponding first electrode sequentially along a second direction. In a first touch mode, the control unit controls the first sensing driving unit to provide a first driving signal to the first electrodes, and controls the second sensing driving unit to receive a plurality of first touch signal from the second electrodes. In a second touch mode, the control unit controls the second driving sensing unit to provide a second driving signal to the second electrodes, and controls the first sensing driving unit to receive a plurality of second touch signal from the first electrodes.

### CROSS-REFERENCE TO RELATED APPLICATION

This application claims the priority benefit of Taiwan application serial no. 102120357, filed on Jun. 7, 2013. The entirety of the above-mentioned patent application is hereby incorporated by reference herein and made a part of this specification.

### BACKGROUND

1. Field of the Invention

The invention relates to a tough apparatus and a driving method thereof, and more particularly, to a capacitive touch apparatus and a driving method thereof.

2. Description of Related Art

In recent years, as applications such as information technology, wireless mobile communication and information appliances have been rapidly developed, to achieve more convenient, more compact and light-volume and more user-friendly designs, various information products have changed from using conventional input devices such as key boards or mice to using touch panels. Nowadays, in general touch panel designs, the design principles of touch sensing mode are roughly classified into a resistive touch panel, a capacitive touch panel, an optical touch panel, an acoustic-wave touch panel, and an electromagnetic touch panel with the capacitive touch panels being the main stream product.

However, when the touch panel is completed, the touch characteristics of the touch panel is fixed; therefore, the touch characteristics of the touch panel cannot change according to the users' needs or the design requirements of the electronic apparatus, thereby limiting the using environment and the using performance of the touch panel. Therefore, it is an important issue to make the touch characteristics of the touch panel able to change to a design touch display panel.

### SUMMARY OF THE INVENTION

The invention provides a touch apparatus and a driving method thereof that may enhance the applicability of the touch apparatus.

The touch apparatus of the invention includes a plurality of first electrodes, a plurality of second electrodes, a first driving sensing unit, a second driving sensing unit and a control unit. The first electrodes are disposed sequentially along a first direction. The second electrodes are disposed between the first electrodes, respectively, and each of the first electrodes is adjacent to the corresponding second electrodes sequentially along a second direction different from the first direction. The first driving sensing unit electrically connects the first electrodes. The second driving sensing unit electrically connects the second electrodes. The control unit electrically connects the first driving sensing unit and the second driving sensing unit and switches to a first touch mode or a second touch mode according to a mode signal. When the control unit is in the first touch mode, the control unit controls the first driving sensing unit to provide a first driving signal sequentially transmitted to the first electrodes and controls the second driving sensing unit to receive a plurality of first touch signals from the second electrodes. When the control unit is in the second touch mode, the control unit controls the second driving sensing unit to provide a second driving signal sequentially transmitted to the second electrodes and controls the first driving sensing unit to receive a plurality of second touch signals from the first electrodes.

The driving method of the touch apparatus of the invention includes the following steps, wherein the touch apparatus includes a plurality of first electrodes and a plurality of second electrodes, the first electrodes are disposed sequentially along a first direction, the second electrodes are disposed between the first electrodes, respectively, and each of the first electrodes is adjacent to the corresponding second electrodes sequentially along a second direction different from the first direction. A mode signal is provided to control a control unit of the touch apparatus to switch to a first touch mode or a second touch mode; when the control unit is in the first touch mode, the control unit provides a first driving signal sequentially transmitted to the first electrodes and receives a plurality of first touch signals from the second electrodes; when the control unit is in the second touch mode, the control unit provides a second driving signal sequentially transmitted to the second electrodes and receives a plurality of second touch signals from the first electrodes.

Based on the above, in the touch apparatus and the driving method thereof in the embodiments of the present invention, the control unit is in the first touch mode or the second touch mode according to the mode signal to correspondingly provide the first driving signal to the first electrodes and the second driving signal to the second electrodes. Based on this, the touch characteristics of the touch apparatus may be adjusted based on the mode signal to enhance the applicability of the touch apparatus.

To make the above features and advantages of the invention more comprehensible, several embodiments accompanied with drawings are described in detail as follows.

### BRIEF DESCRIPTION OF THE DRAWINGS

The accompanying drawings are included to provide further understanding and are incorporated in and constitute a part of this specification. The drawings illustrate exemplary embodiments and, together with the description, serve to explain the principles of the invention.

FIG. 1A is a schematic diagram showing a system of a touch apparatus according to an embodiment of the invention.

FIG. 1B is a schematic driving diagram showing a touch apparatus in a first touch mode according to an embodiment of the invention.

FIG. 1C is a schematic driving diagram showing a touch apparatus in a second touch mode according to an embodiment of the invention.

FIG. 1D is a schematic driving diagram showing a touch apparatus according to an embodiment of the invention.

FIG. 1E is a schematic simulation diagram showing the variation in capacitances of a touch apparatus according to an embodiment of the invention.

FIG. 1F is a schematic diagram showing a system of a touch apparatus according to an embodiment of the invention.

FIG. 2A is a schematic diagram showing a system of a touch apparatus according to another embodiment of the invention.

FIG. 2B is a schematic simulation diagram showing the variation in capacitances of a touch apparatus according to another embodiment of the invention.

FIG. 3 is a flowchart of a driving method of a touch apparatus according to an embodiment of the invention.

### DESCRIPTION OF EMBODIMENTS

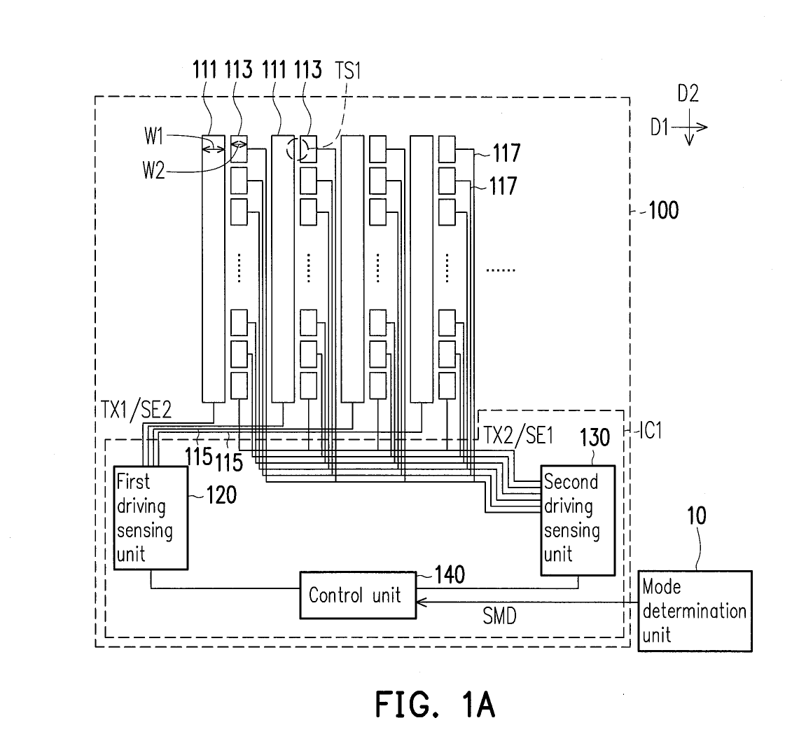

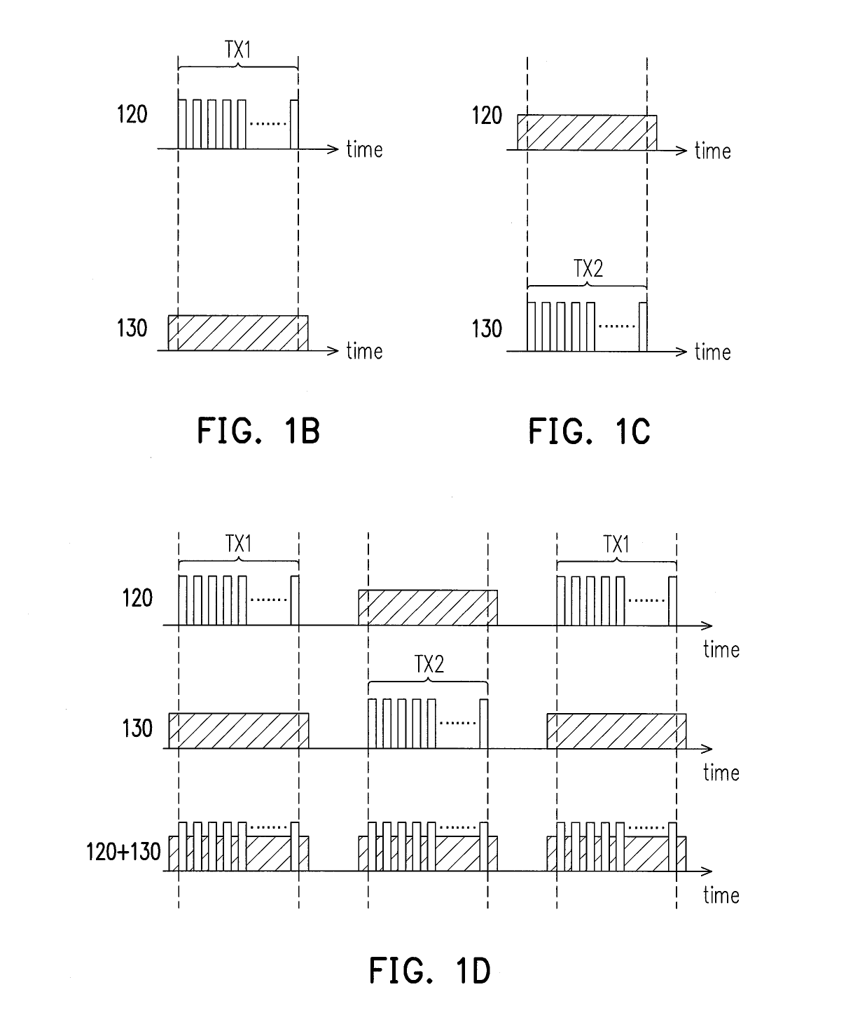

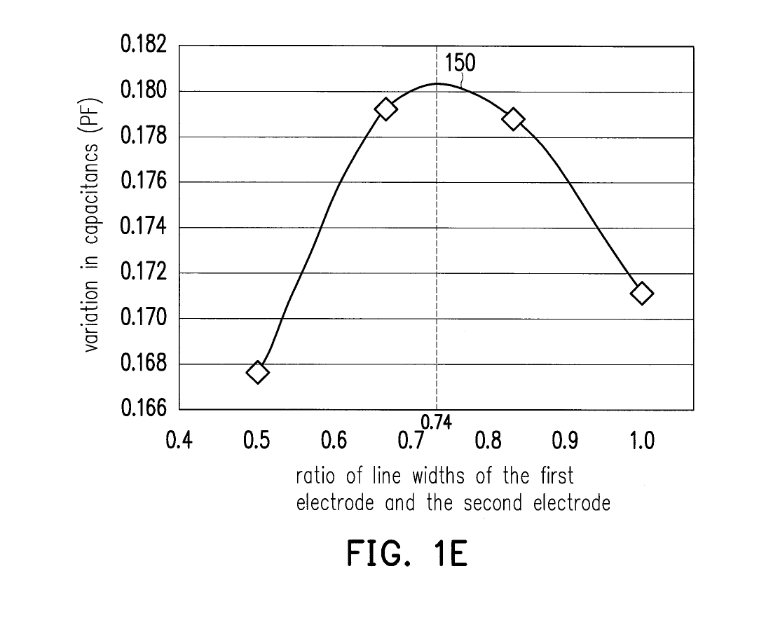

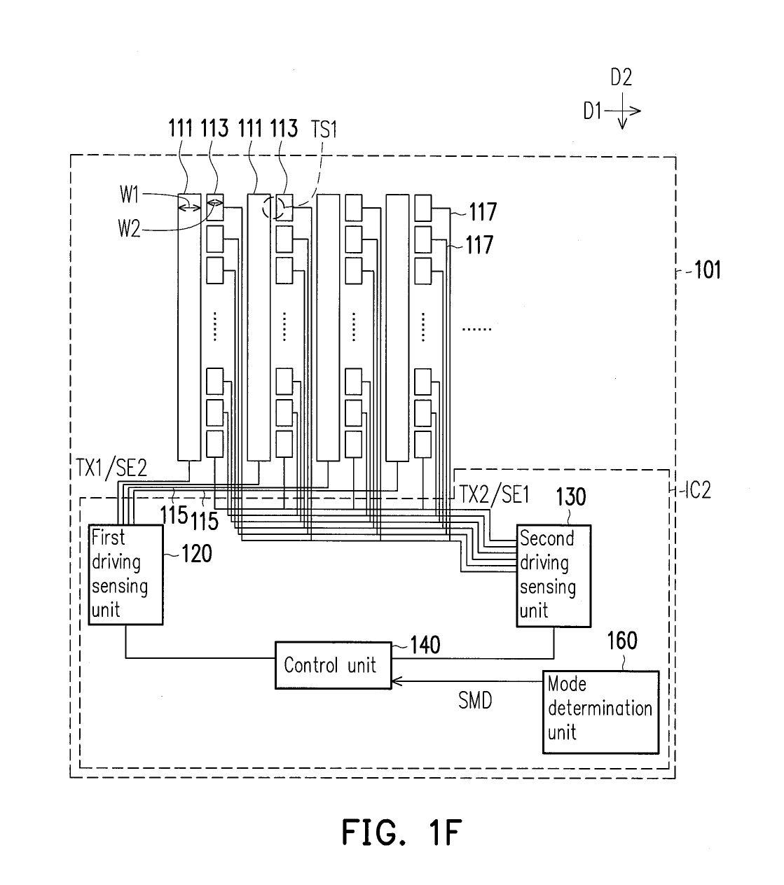

FIG. 1A is a schematic diagram showing a system of a touch apparatus according to an embodiment of the invention. Referring to FIG. 1A, in the present embodiment, a touch apparatus 100 includes a plurality of first electrodes 111, a plurality of second electrodes 113, a plurality of first traces 115, a plurality of second traces 117, a first driving sensing unit 120, a second driving sensing unit 130 and a control unit 140. In addition, in the present embodiment, the first driving sensing unit 120, the second driving sensing unit 130 and the control unit 140 may be integrated into a chip IC1.

The first electrodes 111 are disposed sequentially along a first direction D1. The second electrodes 113 are disposed between the first electrodes 111, respectively, wherein each of the second electrodes 113 is disposed sequentially along a second direction D2 and is adjacent to the corresponding first electrodes 111, and a region where each of the first electrodes 111 is adjacent to the corresponding second electrodes 113 is a touch region (as shown by TS1) of the touch apparatus 100. The first driving sensing unit 120 electrically connects the first electrodes 111 through the first traces 115. The second driving sensing unit 130 electrically connects the second electrodes 113 through the second traces 117.

The control unit 140 electrically connects the first driving sensing unit 120 and the second driving sensing unit 130 to control the first driving sensing unit 120 and the second driving sensing unit 130, and electrically connects a mode determination unit 10 to receive a mode signal SMD. The control unit 140 switches to a first touch mode or a second touch mode according to the mode signal SMD. When the control unit 140 is in the first touch mode, the control unit 140 controls the first driving sensing unit 120 to provide a first driving signal TX1 sequentially transmitted to the first electrodes 111 and controls the second driving sensing unit 130 to receive a plurality of first touch signals SE1 from the second electrodes 113. Then, the control unit 140 may determine whether the touch apparatus 100 is touched based on the transmission timing of the first driving signal TX1 and the corresponding first touch signals SE1. In addition, when the touch apparatus 100 is touched, the control unit 140 may calculate a position of a touch point based on the transmission timing of the first driving signal TX1 and the corresponding first touch signals SE1.

When the control unit 140 is in the second touch mode, the control unit 140 controls the second driving sensing unit 130 to provide a second driving signal TX2 sequentially transmitted to the second electrodes 113 and controls the first driving sensing unit 120 to receive a plurality of second touch signals SE2 from the first electrodes 111. Then, the control unit 140 may determine whether the touch apparatus 100 is touched based on the transmission timing of the second driving signal TX2 and the corresponding second touch signals SE2. In addition, when the touch apparatus 100 is touched, the control unit 140 may calculate a position of a touch point based on the transmission timing of the second driving signal TX2 and the corresponding second touch signals SE2.

In the present embodiment, the first electrodes 111 and the second electrodes 113 do not overlap. At least one side of each of the second electrodes 113 (exemplified by the left side of the second electrodes 113 shown in the drawings) is adjacent to the corresponding first electrodes 111 (exemplified by the first electrodes 111 on the left side shown in the drawings). The other sides of each of the second electrodes 113 (exemplified by the upper, lower and right sides of the second electrodes 113 shown in the drawings) are adjacent to or not adjacent to the corresponding second electrodes 113. According to the above driving method, when the control unit 140 is in the first touch mode, an RC loading resulting from the first electrodes 111 and the second electrodes 113 is lower than an RC loading in the second touch mode. Therefore, power consumption of the touch apparatus 110 operated under the first touch mode may be lowed than power consumption of the touch apparatus 110 operated under the second touch mode, and a scanning speed (or a report rate) of the touch apparatus 100 may be increased under the first touch mode. When the control unit 140 is in the second touch mode, the signal to noise ratio (SNR) of the second touch signals SE2 is higher than the SNR in the first touch mode. Therefore, the possibility of erroneous actions occurring in the touch apparatus 100 is lower; in other words, the accuracy of the touch apparatus 100 is increased.

Based on this, based on the mode signal SMD provided by the mode determination unit 10, the touch characteristics of the touch apparatus 100 change, thereby enhancing the applicability of the touch apparatus 100.

In the present embodiment, the first traces 115 are electrically connected between the corresponding first electrodes 111 and the first driving sensing unit 120, respectively, to transmit the first driving signal TX1 and the corresponding second touch signals SE2. The second traces 117 are electrically connected between the corresponding second electrodes 113 and the first driving sensing unit 130, respectively, to transmit the second driving signal TX2 and the corresponding first touch signals SE1. In addition, the second traces 117 electrically connected by the second electrodes 113 on the same position along the second direction D2 are electrically connected to each other. Furthermore, a portion of the second traces 117 are disposed between the corresponding second electrodes 113 and the first electrodes 111 not adjacent to the corresponding second electrodes 113. In other words, said portion of the second traces 117 can only be disposed an area between the first electrodes 111 and the second electrodes 113 in which the fringe capacitances, electric lines, or electric charges will be omitted by the control unit 140.

In an embodiment of the invention, the mode determination unit 10 sets the mode signal SMD based on time; in other words, the control unit 140 alternates by time between the first touch mode and the second touch mode based on the mode signal SMD. Alternatively, the mode determination unit 10 may detect an application executed by an electronic apparatus (not shown) disposed with the touch apparatus 100 to determine the touch requirements of the application and to set the mode signal SMD according to the touch requirements of the application. In other words, the control unit 140 may be in the first touch mode or the second touch mode according to the mode signal SMD and corresponding to the application executed by an electronic apparatus (not shown) disposed with the touch apparatus 100. Alternatively, the mode determination unit 10 may detect a touch status of a user (such as a single-point touch or a multi-point touch) or a touch medium (such as a touch pen or a finger) used by the user to set the mode signal SMD according to the touch status or the touch medium of the user. In other words, the control unit 140 may be in the first touch mode or the second touch mode according to the mode signal SMD and corresponding to the touch status of the user. The mode determination unit 10 may be a control circuit or a firmware located in the electronic apparatus (not shown), but the embodiments of the invention are not limited thereto.

FIG. 1B is a schematic driving diagram showing a touch apparatus in a first touch mode according to an embodiment of the invention. Referring to FIGS. 1A and 1B, when the control unit 140 is in the first touch mode, the control unit 140 controls the first driving sensing unit 120 to provide a first driving signal TX1 sequentially transmitted to the first electrodes 111 and controls the second driving sensing unit 130 to receive a plurality of first touch signals SE1 from the second electrodes 113 (corresponding to the period shown by the rectangle filled with diagonal lines). In the present embodiment, the first driving signal TX1 is composed of a plurality of pulses.

FIG. 1C is a schematic driving diagram showing a touch apparatus in a second touch mode according to an embodiment of the invention. Referring to FIGS. 1A and 1C, when the control unit 140 is in the second touch mode, the control unit 140 controls the second driving sensing unit 130 to provide a second driving signal TX2 sequentially transmitted to the second electrodes 113 and controls the first driving sensing unit 120 to receive a plurality of second touch signals SE2 from the first electrodes 111 (corresponding to the period shown by the rectangle filled with diagonal lines). In the present embodiment, the second driving signal TX2 is also composed of a plurality of pulses.

Referring to FIGS. 1A and 1C, according to the circuit layout, an equivalent impedance of the first electrodes 111 is smaller than an equivalent impedance of the second electrodes 113. Therefore, a voltage level of the pulse of the first driving signal TX1 transmitted to the first electrodes 111 may be smaller than or equal to a voltage level of the pulse of the second driving signal TX2 transmitted to the second electrodes 113, or a pulse width of the pulse of the first driving signal TX1 transmitted to the first electrodes 111 may be smaller than or equal to a pulse width of the pulse of the second driving signal TX2 transmitted to the second electrodes 113, or the voltage level and the pulse width of the pulse of the first driving signal TX1 transmitted to the first electrodes 111 may be smaller than or equal to the voltage level and the pulse width of the pulse of the second driving signal TX2 transmitted to the second electrodes 113. Persons of ordinary skill in the art may make settings according to the above, and the embodiments of the invention are not limited to the above.

FIG. 1D is a schematic driving diagram showing a touch apparatus according to an embodiment of the invention. Referring to FIGS. 1A and 1D, in the present embodiment, the control unit 140 is in the first touch mode and the second touch mode according to time alternately. When the control unit 140 is in the first touch mode, the control unit 140 controls the first driving sensing unit 120 to provide a first driving signal TX1 sequentially transmitted to the first electrodes 111 and controls the second driving sensing unit 130 to receive a plurality of first touch signals SE1 from the second electrodes 113 (corresponding to the period shown by the rectangle filled with diagonal lines). When the control unit 140 is in the second touch mode, the control unit 140 controls the second driving sensing unit 130 to provide a second driving signal TX1 sequentially transmitted to the second electrodes 113 and controls the first driving sensing unit 120 to receive a plurality of second touch signals SE1 from the first electrodes 111 (corresponding to the period shown by the rectangle filled with diagonal lines). In the present embodiment, the first driving signal TX1 and the second driving signal TX2 are composed of a plurality of pulses, respectively.

FIG. 1E is a schematic simulation diagram showing the variation in capacitances of a touch apparatus according to an embodiment of the invention. Referring to FIGS. 1A and 1E, in the present embodiment, according to the simulation results (as shown by a curve 150), a ratio of line widths W1 and W2 of the first electrode 111 and the second electrode 113 along the first direction D1 is between 0.5 and 1. Further, the ratio of the line widths W1 and W2 of the first electrode 111 and the second electrode 113 along the first direction D1 may be 0.74.

FIG. 1F is a schematic diagram showing a system of a touch apparatus according to an embodiment of the invention. Referring to FIGS. 1A and 1D, a touch apparatus 101 is substantially the same as the touch apparatus 100, and the differences lie in that the touch apparatus 101 further includes a mode determination unit 160 which operates in a way similar to the mode determination unit 10, and that a first driving sensing unit 120, a second driving sensing unit 130, a control unit 140 and the mode determination unit 160 may be integrated into a chip IC2.

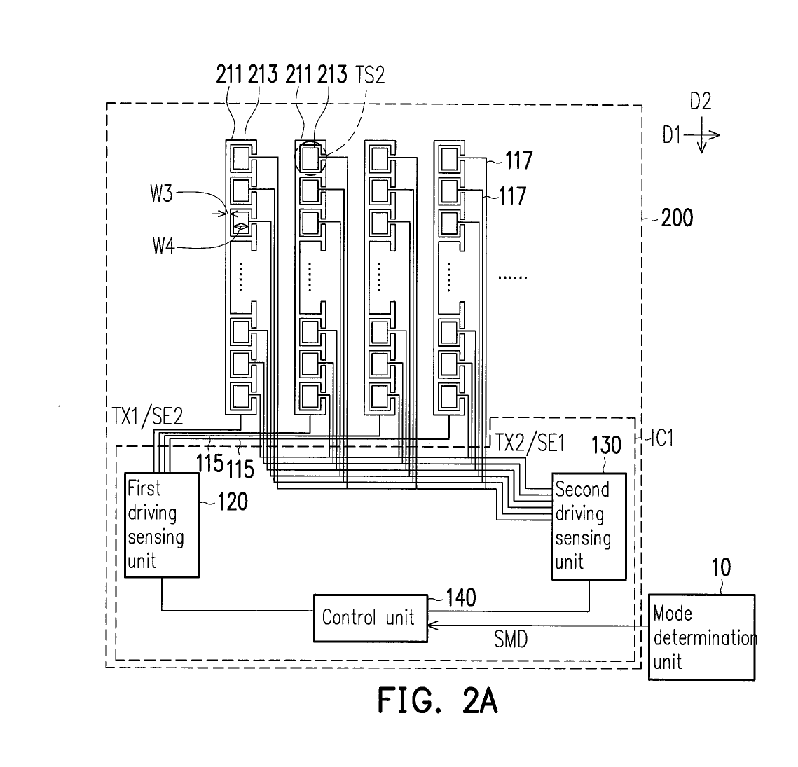

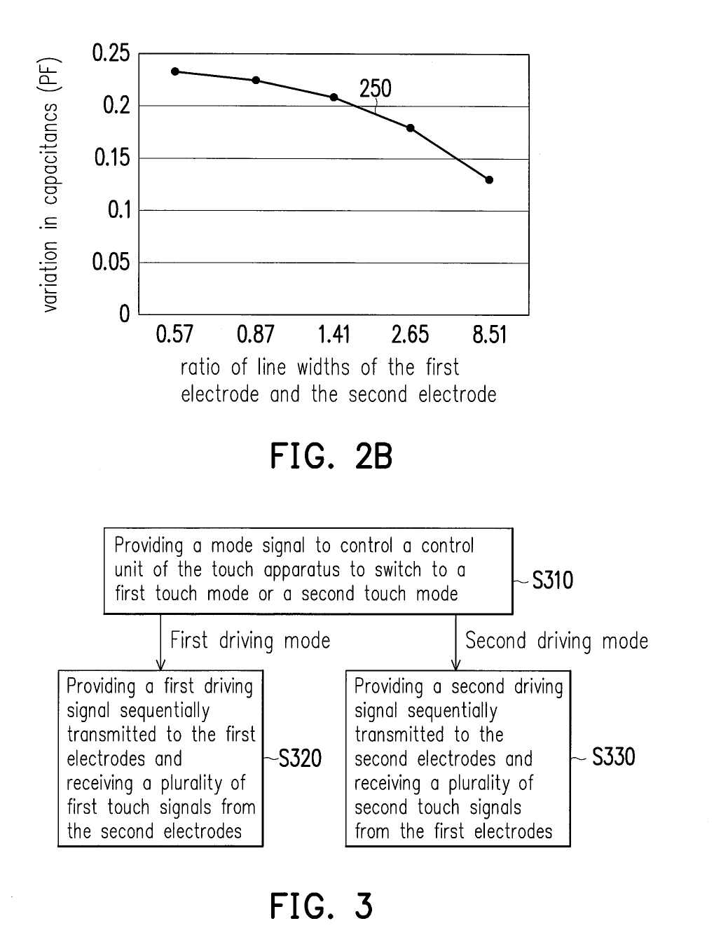

FIG. 2A is a schematic diagram showing a system of a touch apparatus according to another embodiment of the invention. Referring to FIGS. 1A and 2A, in the present embodiment, a circuit structure of a touch apparatus 200 is substantially the same as the circuit structure of the touch apparatus 100, and the differences lie in the disposition way of first electrodes 211 and second electrodes 213, wherein the same or similar elements are represented by the same or similar reference numbers. In the present embodiment, multiple sides of each of the second electrodes 213 are adjacent to the corresponding first electrodes 211, so that a touch region (like TS2) of the touch apparatus 200 is greater than the touch region (like TS1) of the touch apparatus 100.

FIG. 2B is a schematic simulation diagram showing the variation in capacitances of a touch apparatus according to another embodiment of the invention. Referring to FIGS. 2A and 2B, in the present embodiment, according to the simulation results (as shown by a curve 250), a ratio of line widths W3 and W4 of the first electrode 211 and the second electrode 213 along the first direction D1 may be less than 8.5. Further, the ratio of the line widths W3 and W4 of the first electrode 211 and the second electrode 213 along the first direction D1 may be 0.57.

FIG. 3 is a flowchart of a driving method of a touch apparatus according to an embodiment of the invention. Referring to FIG. 3, in the present embodiment, a touch apparatus includes a plurality of first electrodes and a plurality of second electrodes that do not overlap, and the first electrodes are not adjacent to each other but are adjacent to the second electrodes, respectively. A driving method of the touch apparatus includes the following steps. A mode signal is provided to control a control unit of the touch apparatus to switch to a first touch mode or a second touch mode (Step S310). When the control unit is in the first touch mode, the control unit provides a first driving signal sequentially transmitted to the first electrodes and receives a plurality of first touch signals from the second electrodes; when the control unit is in the second touch mode, the control unit provides a second driving signal sequentially transmitted to the second electrodes and receives a plurality of second touch signals from the first electrodes. The sequence of Steps S310, S320 and S330 is for illustration purpose, and the embodiments of the invention are not limited thereto. In addition, the embodiments of FIGS. 1A to 1D, 2A and 2B may be referred to for details of Steps S310, S320 and S330, and the details are omitted herein.

In summary of the above, in the touch apparatus and the driving method thereof in the embodiments of the present invention, the control unit is in the first touch mode or the second touch mode according to the mode signal to correspondingly provide the first driving signal to the first electrodes and the second driving signal to the second electrodes. Based on this, the touch characteristics of the touch apparatus may be adjusted based on the mode signal to enhance the applicability of the touch apparatus. In addition, the first electrodes may be adjacent to multiple sides of the second electrodes to increase the touch region of the touch apparatus.

Although the invention has been described with reference to the above embodiments, it will be apparent to one of ordinary skill in the art that variations and modifications to the invention may be made without departing from the spirit and scope of the invention. Accordingly, the scope of the invention will be defined by the attached claims.

What is claimed is:

1. A touch apparatus, comprising:
a plurality of first electrodes disposed sequentially along a first direction;
a first driving sensing unit electrically connecting the first electrodes;
a plurality of second electrodes disposed sequentially along a second direction different from the first direction;
a second driving sensing unit electrically connecting the second electrodes; and
a control unit controlling the first driving sensing unit and the second driving sensing unit and switching to a first touch mode or a second touch mode according to a mode signal, wherein when the control unit is in the first touch mode, the control unit controls the first driving sensing unit to provide a first driving signal sequentially transmitted to the first electrodes and controls the second driving sensing unit to receive a plurality of first touch signals from the second electrodes, and when the control unit is in the second touch mode, the control unit controls the second driving sensing unit to provide a second driving signal sequentially transmitted to the second electrodes and controls the first driving sensing unit to receive a plurality of second touch signals from the first electrodes.

2. The touch apparatus according to claim 1, wherein a voltage level of the first driving signal is smaller than or equal to a voltage level of the second driving signal.

3. The touch apparatus according to claim 1, wherein a pulse width of the first driving signal is smaller than or equal to a pulse width of the second driving signal.

4. The touch apparatus according to claim 1, wherein at least one side of each of the second electrodes is adjacent to the corresponding first electrodes.

5. The touch apparatus according to claim 4, wherein a ratio of line widths of each first electrode and each second electrode along the first direction is between 0.5 and 1.

6. The touch apparatus according to claim 5, wherein the ratio of the line widths of each first electrode and each second electrode along the first direction is 0.74.

7. The touch apparatus according to claim 1, wherein multiple sides of each of the second electrodes are adjacent to the corresponding first electrodes.

8. The touch apparatus according to claim 7, wherein a ratio of line widths of each first electrode and each second electrode along the first direction is less than 8.5.

9. The touch apparatus according to claim 8, wherein the ratio of the line widths of each first electrode and each second electrode along the first direction is 0.57.

10. The touch apparatus according to claim 1, further comprising:
a plurality of first traces electrically connected between the corresponding first electrodes and the first driving sensing unit, respectively, to transmit the first driving signal and the corresponding second touch signals; and
a plurality of second traces electrically connected between the corresponding second electrodes and the second driving sensing unit, respectively, to transmit the second driving signal and the corresponding first touch signals.

11. The touch apparatus according to claim 1, wherein the second traces electrically connected by the second electrodes on the same position along the second direction are electrically connected to each other.

12. The touch apparatus according to claim 10, wherein a portion of the second traces are disposed between the corresponding second electrodes and the first electrodes not adjacent to the corresponding second electrodes.

13. The touch apparatus according to claim 1, wherein the control unit alternates by time between the first touch mode and the second touch mode based on the mode signal.

14. The touch apparatus according to claim 1, wherein the control unit is in the first touch mode or the second touch mode according to the mode signal and corresponding to an application executed by an electronic apparatus disposed with the touch apparatus.

15. The touch apparatus according to claim 1, further comprising a mode determination unit coupled to the control unit to provide the mode signal.

16. A driving method of a touch apparatus, wherein the touch apparatus includes a plurality of first electrodes and a plurality of second electrodes, the first electrodes are disposed sequentially along a first direction, and the second electrodes are disposed along a second direction different from the first direction, the driving method comprising:
providing a mode signal to control a control unit of the touch apparatus to switch to a first touch mode or a second touch mode;
providing a first driving signal sequentially transmitted to the first electrodes and receiving a plurality of first touch signals from the second electrodes when the control unit is in the first touch mode; and
providing a second driving signal sequentially transmitted to the second electrodes and receiving a plurality of second touch signals from the first electrodes when the control unit is in the second touch mode.

17. The driving method of the touch apparatus according to claim 16, wherein a voltage level of the first driving signal is smaller than or equal to a voltage level of the second driving signal.

18. The driving method of the touch apparatus according to claim 16, wherein a pulse width of the first driving signal is smaller than or equal to a pulse width of the second driving signal.

19. The driving method of the touch apparatus according to claim 16, wherein the control unit alternates by time between the first touch mode and the second touch mode.

20. The driving method of the touch apparatus according to claim 16, wherein the control unit is in the first touch mode or the second touch mode according an application executed by an electronic apparatus disposed with the touch apparatus.

21. The driving method of the touch apparatus according to claim 16, wherein the first direction is perpendicular to the second direction.
